(19) United States
(12) Patent Application Publication
(10) Pub. No.: US 2012/0039358 A1
(43) Pub. Date: Feb. 16, 2012

(54) Device for Measuring Temperature in Electromagnetic Fields

(76) Inventors: Thomas Bosselmann, Marloffstein (DE); Michael Willsch, Jena (DE)

(21) Appl. No.: 13/201,658

(22) PCT Filed: Jan. 28, 2010
(86) PCT No.: PCT/EP2010/050962

§ 371 Date: Oct. 11, 2011

(30) Foreign Application Priority Data
Feb. 24, 2009 (DE) 10 2009 010 289.2

(51) Int. Cl. G01K 11/32

(52) U.S. Cl. 374/161; 374/E11.015

(57) ABSTRACT

For a temperature measurement in areas having electromagnetic fields, shielding devices must be provided. According to the proposed technique, at least one temperature sensor is designed as a fiber-optic sensor having Bragg gratings (FBG), wherein the sensor is arranged in a non-metallic housing that precludes or minimizes expansion effects for the individual FBG sensors. For example, the proposed technique can be used advantageously to measure the temperature distribution in oil sand deposits, for which purpose a suitable measuring arrangement is required.

### CROSS REFERENCE TO RELATED APPLICATIONS

This application is the US National Stage of International Application No. PCT/EP2010/050962, filed Jan. 28, 2010 and claims the benefit thereof. The International Application claims the benefits of German application No. 10 2009 010 289.2 DE filed Feb. 24, 2009. All of the applications are incorporated by reference herein in their entirety.

### FIELD OF INVENTION

The invention relates to a device for measuring temperature in electromagnetic fields. The invention also relates to the use of such a device and to an associated measuring arrangement.

### BACKGROUND OF INVENTION

In the exploitation of underground oil sand deposits it is possible to heat the ground artificially in order to reduce the viscosity of the oil. In the prior art said heating has been achieved by means of hot steam which is pumped into the ground around the oil-bearing formation over a relatively long period of time. The oil becomes free-flowing, settles to the bottom and can thus be more easily extracted by suction.

It is also proposed to use induction heating means to assist the steam injection process. This entails powerful electromagnetic fields being radiated in the ground. The frequency and power are dimensioned such that the radiation energy is absorbed in a defined region around the inductor, thereby heating up the ground. Knowledge of the temperature distribution locally and over time is essential here.

Various fiber-optic measurement methods are available for measuring temperature distributions. Already in use are so-called Raman temperature measurement systems which can measure temperature distributions quasi-continuously with a spatial resolution of approximately 3 in.

The efficiency of induction heating is dependent to a large extent on the nature of the ground in the region of the inductor. In order to monitor the effect of the induction heating method it is therefore necessary to measure the local temperature profile approx. 10 . . . 50 m around the inductor. The spatial resolution must be relatively high here, typically <1 in.

Electrical temperature sensors are ruled out because of the powerful electromagnetic fields. Also precluded is the use of metallic materials in the region of the fields, since currents would be induced in these materials and the latter would also heat up. Additional problems are the presence of aggressive gases, and severe mechanical stresses placed on long sensor cables extending deep into a borehole.

### SUMMARY OF INVENTION

Based on the above prior art, the object of the invention is to create a suitable device which operates on the principle of distributed temperature sensors and which can be used in particular in the case of oil deposits which are at least to some extent electrically heated in order to liquefy viscous oil. An associated measuring arrangement shall be created for this purpose.

The object is achieved according to the features of the independent claims. Developments of the device according to the invention, specific uses of said device and developments of the associated measuring arrangement are the subject matter of the dependent claims.

The invention was based on the knowledge that the FBG temperature sensors known from the prior art can be advantageously used for the application described above. Said sensors can in particular be implemented in chains with any desired sensor spacing in order to achieve a spatial resolution better than 1 m. Depending on the evaluation scheme, up to 500 sensors can be evaluated simultaneously.

With the invention it is specifically proposed to guide the sensor fibers with the FBGs loosely into a capillary. Said capillary is made of nonmetallic material, preferably fused quartz, GRP, PEEK, Teflon and other nonmetallic materials, or a combination or coating of such materials. The inner surface must be smooth in order to allow the fibers to move freely. In order to minimize frictional forces between sensor fiber and capillary, the capillary must be stretched out straight in measuring mode. To ensure that this happens, the capillary must have sufficient inherent rigidity to straighten itself when freely suspended or slightly pretensioned.

According to the invention the capillary is advantageously likewise free to move in a protective tube. To enable the capillary to move freely therein, the protective tube must also exhibit high rigidity and have smooth inner walls. Thermal expansion and mechanical stresses exerted on the protective tube must not penetrate to the sensor capillary. The protective tube is preferably made of GRP. A jacket of high-temperature-resistant plastic is used as external protection. This can be provided with strain relief, e.g. consisting of GRP rods. To prevent excessive mechanical stress on the protective tube, a softer buffer layer can be inserted between outer jacket and protective tube.

Within the scope of the invention the Bragg sensors are preferably evaluated in per se known manner using a polychromator, an Si-CCD-based miniature spectrometer and a very wideband light source. Given a wavelength range of 200 nm, 100 sensors at 2 nm spectral intervals can be evaluated in this way. This advantageously results in a measuring section of 50 m with two sensors per meter.

A particularly advantageous use of a measuring arrangement comprising a device according to the invention is the recording of temperature distributions in raw material deposits, particularly in oil reservoirs, which are heated in order to improve the flow characteristics. Specifically oil sand deposits, but also oil reservoirs under the seabed, are possible applications.

### BRIEF DESCRIPTION OF THE DRAWINGS

Further details and advantages of the invention will emerge from the following description of exemplary embodiments with reference to the accompanying drawing taken in conjunction with the relevant claims.

In the drawing:

FIG. 1 shows the cross-section of a sensor module,

FIG. 2 shows the longitudinal section of a sensor module according to FIG. 1 with a freely movable end cap,

FIG. 3 shows the longitudinal section of a sensor module according to FIG. 1 with an end cap in which the capillary is pretensioned,

FIG. 4 shows an oil sand deposit as a preferred exemplary application of temperature measurement using the sensor module according to the invention, and

FIG. 5 shows a measuring arrangement in an oil sand deposit with a sensor topology comprising a plurality of modules.

### DETAILED DESCRIPTION OF INVENTION

Crude oil is found in reservoirs as an extensive natural deposit (cavity, bed). Particularly in onshore oil sands, carbonaceous matter is present in bitumen or heavy oil consistency and must be made to flow prior to extraction. Also in the case of submarine (offshore) reservoirs, the oil is viscous because of the temperature obtaining there. This applies particularly to polar regions with arctic temperatures.

Oil sand deposits in particular can be heated, as is known, using so-called SAGD technology by means of steam, or also electrically, in particular using induction heating. In the prior art in accordance with DE 10 2007 036 832 A1 and DE 10 2007 040 605 A1, for example, induction heating is combined with SAGD (Steam Assisted Gravity Drainage) heating. Suitable inductor arrangements for the latter purpose are described specifically in the older, but unpublished German patent application AZ 10 2008 062 326.1.

If the raw material deposit is an underwater (offshore) oil reservoir, in order to improve the flow characteristics the oil is usually chemically treated or likewise heated “in situ”, which can likewise be performed by induction.

Specifically as a result of induction heating of the deposit, the region of interest is at least partially subjected to powerful electromagnetic fields, making it problematic to use metal sensors for temperature measurement. Only nonmetallic materials such as GRP or PEEK can be employed. In this context, temperature sensors with fiber Bragg gratings (FBG), which in particular achieve the spatial resolution required for this application, have proved suitable.

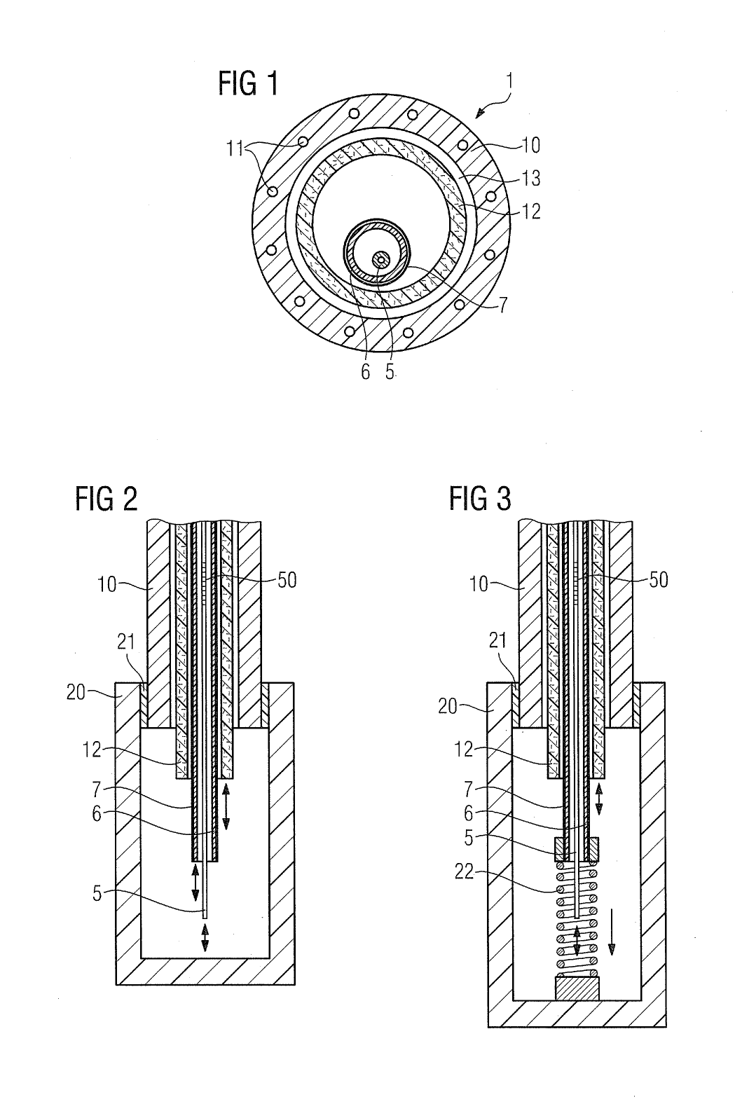

A nonmetallic yet robust packaging for FBG sensors of this kind will be described with reference to FIGS. 1 to 3. The sensors are denoted altogether as a module by 1, . . . . The packaging or housing is specially designed to prevent expansion effects on such FBG sensors (1, 1′, . . . ).

In detail, it is proposed to guide the sensor fibers with the FBG loosely in a capillary. Said capillary is nonmetallic, preferably being made of fused quartz, GRP, PEEK, Teflon and other materials, or a combination or coating of different materials. It is required that the inner surface is smooth to enable the fibers to move freely. In order to minimize frictional forces between sensor fiber and capillary, the capillary must be stretched out straight in measuring mode. To ensure that this happens, the capillary must have sufficient inherent rigidity in order to straighten itself when freely suspended or slightly pretensioned.

The capillary can likewise move freely in a protective tube. To enable the capillary to move freely, the protective tube must also exhibit high rigidity and have smooth inner walls. Thermal expansion and mechanical stresses exerted on the protective tube must not penetrate to the sensor capillary. The protective tube is preferably made of glass-reinforced plastic GRP. A jacket of high-temperature-resistant plastic is used as external protection. This can be provided with strain relief, e.g. consisting of GRP rods. To prevent excessive mechanical stress on the protective tube, a softer buffer layer can be inserted between outer jacket and protective tube.

In FIG. 1, an optical waveguide with fiber Bragg grating (FBG) is denoted by 5. Such an optical waveguide with circular cross-section is disposed in a capillary 6 with a coating 7 and is longitudinally displaceable in said capillary. The capillary 6 is disposed in an outer sheath 10 with reinforcing members 11, a protective tube 12 of e.g. glass-reinforced plastic (GRP) being disposed inside said outer sheath 10. Between protective tube 12 and outer sheath 10 there is a free space 13 which is implemented, for example, as an air layer. However, a particular material can also be disposed thereon so that another buffer layer is formed. The buffer material consists in particular of silicone gel or the like and has good heat-conducting properties in order to provide a sufficient temperature connection of the individual Bragg sensors.

As the supply lead to the measuring location may well be several 100 m long, the measuring section must be decoupled from the supply lead. Conventional fiber-optic cables for use in boreholes can be used as supply leads. These can also contain metal elements.

The measuring section is implemented as a self-contained module 1 encapsulated front and back and typically 10 to 50 m long which is only reelable with a large radius >1 m. The end of the sensor capillary can move freely in the end piece of the module 1. Alternatively, the sensor capillary can be slightly pretensioned. This can prevent the sensor capillary from twisting. The module must be impermeable to aggressive gases and hydrogen in one layer. If required, a plurality of sensor modules can be cascaded.

FIGS. 2 and 3 show the longitudinal section through the arrangement according to FIG. 1. The end cap is denoted by 20 in FIGS. 2 and 3. In FIG. 2, the optical waveguide can move freely in the axial direction in the end cap 20, as indicated by the double arrow. For this purpose the end cap 20 is seated on the outer sheath 10 by means of a sleeve-shaped sliding bearing 21 so that the protective tube 12 can move longitudinally inside.

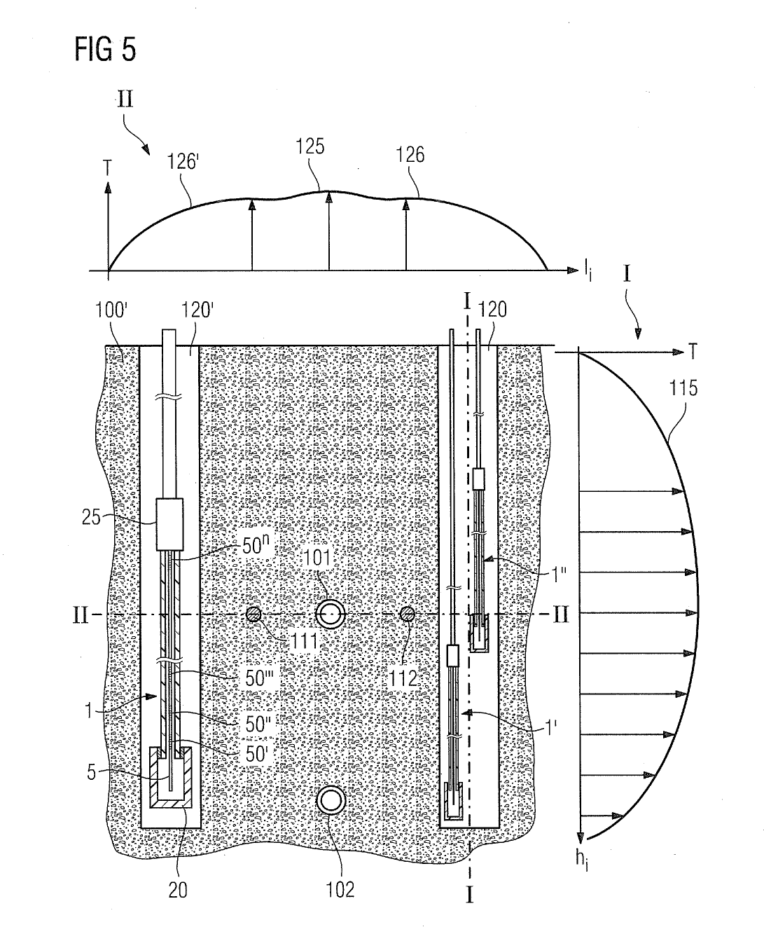

At the other end of the housing sheath 10 is a connector cap 25 (not shown in FIG. 2/3) for connecting a standard glass fiber cable 20. This is shown in detail in FIG. 5.

As an alternative, in FIG. 3 the end cap is disposed on the outer sheath 10 such that the capillary 2 is secured via an internal spring 22, thereby providing internal pretensioning of the capillary. For this purpose the spring 22 is shrunk on the capillary with a fixing element 23.

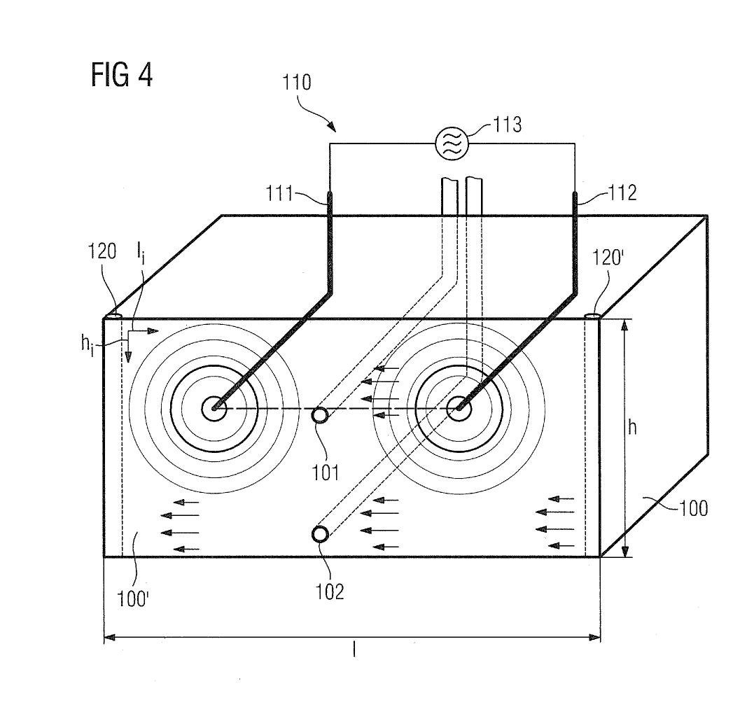

FIG. 4 shows a detail of a reservoir denoted by the reference numeral 100, containing an injection pipe 101 for heating by means of steam and an inductor device 110 for electric heating. If required, heating can take place via the inductor only. Additionally present is a production pipe 102 for receiving the liquefied oil.

The inductor device 110 consists of an outgoing conductor 111 and a return conductor 112 as well as a power generator 113 supplying the conductors and is described in detail in the older applications DE 10 2007 036 832 A1 and DE 10 2007 040 605 A1. Specific reference is made to the disclosure of these separate patent documents.

It is advantageous if specifically dielectric heating (radio frequency up to the microwave range) is combined with an SAGD heating method. On the other hand, the reservoir 100 can be dielectrically heated only.

In the sectional view according to FIG. 5, boreholes 120, 120′ in which a plurality of measuring modules 1, 1′, 1″ are located are present in the reservoir 100. Inserted in the borehole 120, for example, are two sensors 1′, 1″ with outer sheath 10, 10′ and capillaries. Standard cables 15 which can be between 100 and 1000 m long are attached to the probe outer sheaths 10, 10′. The actual probes with fiber Bragg grating (FBG), on the other hand, have a length of 10 to about 50 m. Two probe modules 1′, 1″ can have overlapping measuring ranges.

The arrangement is installed in a nonmetallic tube which has previously been inserted deep into the deposit as a vertical casing for preserving the borehole. The arrangement in the borehole can then be backfilled e.g. with a bentonite mass such that a thermally conductive coupling of the sensor to ambient is achieved, the filling material having approximately the thermal conductivity of the medium surrounding the bore.

The distributed temperature sensor can be implemented by the appropriate arrangement of individual measuring modules 1, 1′, 1″, . . . .

Plotted in FIG. 5 is a first temperature profile 115 showing the temperature variation over the length of the borehole 120 (intersecting line I-I in FIG. 5), i.e. T=f(1₁). Also plotted is a second temperature profile 125 along the plane of the inductor outgoing conductor—injector pipe—inductor return conductor, showing the temperature response over the cross-section (intersecting line II-II in FIG. 5), i.e. T=h(1ᵢ).

In this equation h and 1 are determining variables for the volume segment 100 or rather the projection 100′. As a result of induction heating, the temperature profile 125 is homogenized with the lateral regions 126, 126′. If required, induction heating only can take place, wherein the generator 113 can be open- or closed-loop controlled by open-/closed-loop control signals which are received by the temperature sensors via the lightguides after optoelectronic conversion in a signal processing unit not shown in detail.

In the above description it has been assumed that, for temperature measurement in regions with electromagnetic fields, shielding devices must be provided. According to the invention, at least one temperature sensor is implemented as a fiber-optic sensor with Bragg gratings (FBG), wherein the sensor is disposed in a nonmetallic housing which eliminates expansion effects for the individual FBG sensors. Such a device can be advantageously used to measure the temperature distribution in oil sand deposits, for which purpose a suitable measuring arrangement is required. A measuring arrangement comprising a plurality of such devices forms a distributed temperature sensor wherein the devices are guided parallel to one another in boreholes in the deposits.

1.-25. (canceled)

26. A device for measuring temperature in media subject to electromagnetic fields, comprising:
at least one temperature sensor, wherein the at least one temperature sensor is embodied as a fiber-optic sensor comprising at least one fiber Bragg grating, and
a housing in which the at least one temperature sensor is disposed, wherein the housing is non-metallic such that expansion effects are eliminated or at least reduced for the at least one temperature sensor with the at least one fiber Bragg grating.

27. The device as claimed in claim 26, wherein the at least one fiber-optic sensor is guided as an optical waveguide in a respective capillary which has an inherent rigidity sufficient to straighten the optical waveguide when freely suspended or slightly pretensioned.

28. The device as claimed in claim 27, wherein at least one capillary with optical waveguide is freely movable in a protective tube.

29. The device as claimed in claim 28, wherein a plurality of capillaries with optical waveguide are freely movable in the protective tube.

30. The device as claimed in claim 28, wherein the protective tube has high rigidity and smooth inner walls.

31. The device as claimed in claim 28, wherein the protective tube is made of a glass reinforced plastic (GRP) material.

32. The device as claimed in claim 28, wherein the protective tube is disposed in an outer sheath, a free space being present between outer sheath and protective tube.

33. The device as claimed in claim 32, wherein reinforcing members are present in the outer sheath.

34. The device as claimed in claim 33, wherein the outer sheath is made of temperature-resistant plastic and the reinforcing members are made up of a glass reinforced plastic (GRP) material.

35. The device as claimed in claim 32, wherein a buffer material for heat conduction is disposed in the free space between outer sheath and protective tube.

36. The device as claimed in claim 28, wherein the protective tube has an end cap which is freely movable in the axial direction.

37. The device as claimed in claim 36, wherein the capillary for the fiber-optic sensor is pretensioned in the end cap.

38. A method for temperature measurement in an extensive raw material deposit which is at least to some extent subject to electromagnetic fields, comprising:
measuring a localized temperature in the raw material deposit using one or more measuring devices, each measuring device comprising at least one temperature sensor, wherein the at least one temperature sensor is embodied as a fiber-optic sensor with at least one fiber Bragg grating, the sensor being disposed in a nonmetallic housing module such that expansion effects are eliminated or at least minimized for the individual sensors with the at least one fiber Bragg grating.

39. The method as claimed in claim 38, wherein the raw material deposit is an oil sand reservoir which is electrically heated.

40. The method as claimed in claim 39, wherein, to heat the oil sand deposit, induction heating is combined with a steam assisted gravity drainage (SAGD) heating method.

41. The method as claimed in claim 39, wherein at least two measuring devices are guided parallel to one another in boreholes of the reservoir.

42. A measuring arrangement comprising at least one measuring device for localized temperature measurement in an extensive raw material deposit which is at least to some extent subject to electromagnetic fields, wherein each measuring device comprises:
at least one temperature sensor, wherein the at least one temperature sensor is embodied as a fiber-optic sensor with at least one fiber Bragg grating, the sensor being disposed in a nonmetallic housing module such that expansion effects are eliminated or at least minimized for the individual sensors with the at least one fiber Bragg grating,
wherein one or more measuring devices are guided in a borehole in the deposit at a defined distance from a steam injection pipe and/or an electrical inductor.

43. The measuring arrangement as claimed in claim 42, wherein two of the measuring devices are guided in parallel in a borehole and overlap in the measuring range.

44. The measuring arrangement as claimed in claim 42, wherein the device(s) is/are connected via lightguides to an optoelectronic signal processing unit.
